(19) United States
(12) Patent Application Publication
(10) Pub. No.: US 2009/0025651 A1
(43) Pub. Date: Jan. 29, 2009

(54) Automated animal return system

(76) Inventor: Tom Lalor, North Vancouver (CA)

Correspondence Address: Jeffrey S. Sokol, Esq.;Cook & Franke S.C., 600 E. Mason Street, Milwaukee, WI, 53202, US

(21) Appl. No.: 12/284,700

(22) Filed: Sep. 24, 2008

Related U.S. Application Data
(63) Continuation of application No. 11/158,572, filed on Jun. 22, 2005.
Application No. 11/158,572 is a continuation-in-part of application No. 10/716,365, filed on Nov. 18, 2003, now abandoned.

(51) Int. Cl. A01K 15/04; A01K 15/00

(52) U.S. Cl. 119/719; 119/712; 119/721

(57) ABSTRACT

An automated animal return system for controlling animals, including dogs and other pets, and for automatically returning such animals to a predetermined containment area. The system uses positive reinforcement training so as to avoid the development of animal confusion and nervousness. The system includes a locator for determining the position of the animal relative to a reinforcement/reward zone, a command system for issuing a command to the animal when the animal is detected within a first boundary zone located beyond the reward zone, to encourage the animal to return to the reward zone, and a positive reinforcement system for providing a reinforcer to the animal when the locator system detects that the animal has returned to the reward zone from the first boundary zone in response to the command. The reinforcer may be an audible reinforcer or an edible reinforcer or both.

### RELATED APPLICATIONS

This application is a continuation of U.S. application Ser. No. 11/158,572, filed Jun. 22, 2005 (pending), which is a continuation-in-part of U.S. patent application Ser. No. 10/716,365, filed on Nov. 18, 2003 (now abandoned).

### FIELD

The present invention relates generally to an automated animal return system for controlling animals, including dogs and other pets. In particular, the automated animal return system described herein relates to a system for automatically returning such animals to a predetermined containment area.

### BACKGROUND

Systems for controlling animals, including dogs and other pets, and causing them to return to a predetermined containment area are known in the art. Typically, these systems use a radio frequency (“RF”) signal generator to drive a loop antenna strung out, and perhaps buried, around the boundary of the containment area. When energized, the antenna defines a virtual fence comprising radiating RF signals in the vicinity of the boundary. A matched RF signal receiver is attached to the animal's collar. When the animal approaches the energized boundary antenna, the matched receiver picks up the signal from the antenna and activates an electric circuit in the collar to produce a shock to the animal through electrodes which protrude from the collar into the animal's neck. As an alternative to a shock, a discomforting loud noise can be created, which is intended to annoy the animal and drive it back from the boundary to the containment area. A system exemplary of the above is describe in U.S. Pat. No. 3,753,421, issued to Richard M. Peck on Aug. 21, 1973.

Such systems require that the boundary location be learned by the animal. If only a shock is given as the animal approaches the boundary, the animal may become confused as it may not associate the shock with its location near the boundary. Thus, such systems are often combined with flags placed on the boundary and/or an audible sound, to give the animal some warning that it is getting close to the boundary. The animal thus associates the warning and subsequent shock with the boundary area. As the animal learns not to go near the boundary the flags and sound warning are removed.

It is also typical that these systems will increase the intensity of the electric shock or discomforting noise as the animal approaches closer to the boundary antenna.

Another system for controlling animals to remain within a predetermined containment area is described in U.S. Pat. No. 4,745,882, issued to Yarnell et al. on May 24, 1988. This system additionally includes a hand held RF transmitter (or “walkie talkie”) for use by the animal owner, and a matched RF receiver attached to the animal (usually on a collar). The transmitter is capable of sending the trainer's verbal commands to the animal's receiver unit to order the animal to return once it has escaped the containment area.

In U.S. Pat. No. 5,207,179, issued to Arthur et al. on May 4, 1993, as the animal approaches the boundary antenna, a prerecorded voice command is transmitted from a control panel to a receiver on the animal's collar to encourage the animal to withdraw from the boundary. A shock is applied to the animal if the voice commands are ignored and the animal approaches closer to the boundary.

Other known containment systems are available that use global positioning systems (“GPS”), ultrasonic signals or accelerometer technologies to locate the position of the animal relative to a containment boundary prior to issuing a warning or administering a shock or some other discomfort.

There are several disadvantages associated with these existing animal return or containment systems. First, all of these systems take a positive punishment or negative reinforcement approach to containment since they only offer aversives or discomfort to the animal, sometimes preceded by a warning tone or voice command. Negative reinforcement or positive punishment can result in the animal becoming confused, nervous and de motivated. Many animals do not realize why they are being punished. They understand and associate the discomfort with the exact thing they were doing at the time the discomfort was administered. If the animal was looking at a tree, it may be convinced that the tree produced the discomfort. In most cases, the animal may not associate its location near the boundary of a containment area or its disobedience of a command to the discomfort. None of these existing systems use positive reinforcement, such as giving the animal a food reinforcer, in response to the animal returning to the containment area. It is well known that positive reinforcement, or reward training, is a much more effective behavioural training method than negative reinforcement or positive punishment systems due to the decreased possibility of negative side effects in the animal, such as nervousness, cowering, flinching, crawling, or the like. It would therefore be advantageous to develop an automated animal return system that uses positive reinforcement training.

Second, as noted above, existing systems require that the animal learn the location of containment area boundary lines and that the boundary lines remain relatively fixed. Such learning may take several days or weeks. Therefore, these systems are limited to use in a fixed location and cannot easily be adapted for use when taking the animal away for the weekend on a camping trip. Moreover, it is not easy to change the size of the boundary area. It would therefore be advantageous to have an automated animal return system that could be moved to a new location and where the containment area could be changed in size without the need for the animal to relearn the boundary.

Third, the existing return or containment systems require consistency. You cannot use the systems one day, then the next day, turn them off and play “fetch” with your dog across the containment area boundary line. If you do, the next day your dog will not understand that the system has once again been activated. It will become confused and nervous. It would therefore be advantageous to develop an automated animal return system that could be used intermittently and that does not create confusion or nervousness in the animal.

It is well known that in order to teach or alter an animal's behaviour, a system, whether automated or manual, must have two key elements. First, an effective method of operant conditioning, and second, a good system for shaping the desired behaviour. Operant conditioning is a process of learning or behaviour modification in which the subject comes to associate a certain behaviour (or operant) with a previously unrelated consequence, such as reinforcement or punishment. Shaping is the process of reinforcing successive approximations of a desired behaviour, thereby rewarding performance that gets closer to the ideal behaviour. Reinforcement is anything that increases the likelihood a behaviour will occur again, while punishment is anything that decreases the likelihood that a behaviour will occur again. Punishment and reinforcement can be either positive (adding something to the system) or negative (removing something from the system). Those skilled in the art will understand that operant conditioning falls into the following four categories:

Positive Reinforcement—means that by adding something the animal wants, you increase the likelihood that the behaviour will occur again. For example, if you teach an animal to come by giving it a treat when it comes in response to your command, you are using positive reinforcement. You are giving the animal something it likes (a reinforcer) to increase the likelihood that it will come to you the next time you call. Many people use the term “reward” to describe the concept of positive reinforcement. A “reward” is defined as a return for a service or behaviour and is generally thought to be something positive that will increase the likelihood of the behaviour occurring again. Accordingly, in the present application, the term “reward” will be used to refer to something that the animal likes, such as food or a pleasing sound, that is given to the animal after it executes a desired behaviour, to increase the likelihood that the behaviour will occur again. The term “reward” may sometimes be used interchangeably with the terms “positive reinforcement” or “reinforcer”.

Negative Reinforcement—means that by removing an aversive, something the animal dislikes, you increase the likelihood the behaviour will occur again. For example, if you want to teach the animal to come by putting it on a leash and choke chain and yanking on the leash until the animal takes a step forward, and as soon as it comes forward you release the pressure, then you are using negative reinforcement. By removing the pressure as soon as the animal starts coming, you increase the likelihood that it will come the next time in order to avoid the yanking. In a containment system, if you want to increase the likelihood that the animal will return to the home region, you add shock until it starts to go back into the home region and then immediately remove the shock.

Positive Punishment—means that by adding something aversive you will decrease the likelihood that the behaviour will occur again. For example, if an animal raids the garbage can looking for food when you are not around, you can booby-trap the garbage with mouse-traps. The next time the animal sticks its nose in the garbage can in search of a snack, it gets a mouse trap surprise, which is frightening. By adding the booby-trap punishment you decrease the likelihood that the animal will repeat the raid on the garbage can. Most animal containment systems use this type of operant conditioning. When the animal tries to escape, a shock/punishment is added, which will decrease the likelihood that the animal will try to escape again.

Negative Punishment—means that by removing something the animal wants you decrease the likelihood that the behaviour will occur again. For example, when an animal greets us by jumping up at us, its goal is to get our attention. If we remove our attention every time the animal jumps up, by holding perfectly still and even looking away, eventually the animal will stop jumping up. By removing the attention (something the animal wants), we decrease the likelihood that the animal will jump again.

In general, the continuous use of aversives (something the animal wants to avoid) to train behaviour (whether it be positive punishment or negative reinforcement) can be ineffective and have many undesirable side effects. The pitfalls include:

1. The aversive has to be strong enough to stop the behaviour. If it is not strong enough, then the animal may perform the behaviour and actually habituate to the level of the aversive. Consequently the intensity of the aversive must be constantly increased.

2. If the aversive is too intense it may cause physical injury or fear that may generalize to other contexts.

3. Aversives that cause pain can cause aggression that is directed at any object (including people and other animals) near the affected animal.

4. The aversive must be consistently administered every time the animal performs the undesirable behaviour. Otherwise, the undesirable behaviour will be unintentionally reinforced, which then puts the undesirable behaviour on a variable schedule of reinforcement. Variable reinforcement is the strongest schedule of reinforcement and consequently the undesirable behaviour can become stronger.

5. Punishment and aversives can become rewarding if they predict something pleasurable will happen. This is the basis for some self mutilating behaviour in children.

6. The aversive does not teach alternate appropriate behaviours.

Even when an aversive is used appropriately, it may be ineffective because the animal is not taught an alternate appropriate behaviour. For aversives to have a long term effect in animals that have a high desire to perform the undesired behaviour, the animal must receive positive reinforcement (usually food, play, attention, whatever the animal likes) to reinforce and encourage a more appropriate behaviour.

Currently, automated animal return or containment systems that rely on positive punishment or negative reinforcement (aversives) to deal with an undesired behaviour (usually to stop an undesired behaviour), do not also employ positive reinforcement to reward the desired behaviour. For example, in U.S. Pat. No. 6,263,836, issued to Robert Hollis on Jul. 24, 2001, Hollis describes a behaviour monitoring system and training apparatus that can be used to keep an animal within a confinement zone by monitoring the behaviour of the animal and using aversive stimulators such as electric shocks and voice correction or combinations thereof. In the training apparatus describe by Hollis, as the animal moves toward the boundary of the containment zone a warning stimulus/shock is given to the animal to deter further movement toward the boundary. Should the animal continue to move toward the boundary, the system provides the main stimulus, which is an increased electrical stimulation or a different voice or sound correction, again designed to deter further movement of the animal toward the boundary. If the animal backs off and returns to the inner confinement area, the main stimulus will stop. If the animal ignores the main stimulation and continues through the boundary, outside the containment boundary the stimulus is cancelled, thereby allowing the animal to return without receiving a shock.

In the Hollis system, if the animal moves farther away and outside the range of the containment signal, a voice message, such as “GO HOME”, is played from a speaker on the animal's collar. If the animal chooses to obey the command it is allowed to return to the containment zone without getting shocked and the system resumes normal operation.

Those skilled in the art will appreciate that the operant conditioning used by Hollis is both positive punishment and negative reinforcement, however, Hollis does not employ positive reinforcement. Consider that in an animal return or containment system such as that described by Hollis, the operant behaviours are either escaping from or returning to the containment zone. Ideally, the animal owner will want to decrease the occurrence of the escaping behaviour and increase the occurrence of the returning behaviour. To reduce the occurrence of the escaping behaviour, Hollis uses positive punishment by adding an aversive shock when the animal approaches the containment wire to decrease the likelihood that the behaviour will occur again. To increase the likelihood of the returning behaviour, Hollis uses negative reinforcement by removing the aversive stimulus when the animal backs away from the containment wire and remains in the containment zone. At no time does the system described by Hollis use positive reinforcement to add something the animal wants to increase the likelihood that a desired behaviour will occur again. That is, Hollis never rewards the animal for returning to or remaining in the containment zone.

In the system described by Hollis, if the animal rushes through the boundary and outside the containment wire the aversive stimulation is simply turned off. The animal is allowed to return without getting shocked, if it chooses, but in this situation, the animal may actually learn, by negative reinforcement, that if it rushes through the barrier outside the containment area, the aversive stimulation will be removed. Therefore it may increase the occurrence of this escaping behaviour.

In the event the animal moves beyond the range of the containment signal a voice message issues from the speaker on the remote unit telling the animal to “GO HOME”. Again, the animal is allowed to return to the containment area without getting shocked, but no conditioning/learning takes place, since nothing is being added or removed to encourage or decrease this behaviour. In this situation, the animal would probably never respond to the “GO HOME” command since the command is never paired with a reinforcer immediately upon the animal's return to the containment area. At the time the “GO HOME” command is issued the aversive has already been cancelled, and no reward is given to the animal if it decides to return to the containment area.

Punishments and/or reinforcers have to occur as or immediately after (preferably within 1 second) the operant behaviour so that the animal associates the punishment or reinforcer with the behaviour. Cues or commands, such as the “GO HOME” command have to be learned by the animal. The proper way to teach the animal is to first teach the behaviour and then later train the animal to associate the command or cue with the behaviour. The only way the Hollis system could teach a “GO HOME” command to the animal is if the aversive stimulation stayed on the whole time while the animal was outside the containment area and then immediately turned off as the animal headed back to the containment area (negative reinforcement). In that case, the “GO HOME” command would have to occur right before the animal started heading back to the containment area. No such teaching is found in Hollis, since by the time the “GO HOME” command is issued, the shock has already been completely turned off. Hollis provides no means for the animal to learn that it should return to the confinement area upon hearing the “GO HOME” command. Moreover, Hollis does not use positive reinforcement to reward behaviour and does not describe a command system designed to issue a command to the animal to encourage the animal to return to the containment zone to receive a positive reinforcement.

U.S. Pat. No. 6,273,027, issued to Watson et al. (“Watson”) on Aug. 14, 2001, describes an automated training device and method that does not use aversives to stop an animal from exhibiting an undesired behaviour, such as escaping. To prevent escaping, Watson provides a food dispenser for dispensing food pellets at regular intervals and a pressure sensitive mat or tethered chewtoy to detect the position of the animal. When the animal remains on the mat or continues to chew the toy, it continues to receive the food pellets at regular timed intervals. If the animal leaves the mat or stops chewing the toy, the periodic dispensing of food pellets stops. In Watson, the operant behaviours are escaping and remaining on the mat or chewing the toy. To increase the behaviour of remaining on the mat or chewing the toy, Watson uses positive reinforcement in the form of regular, timed dispensing of food. To decrease the escaping behaviour, Watson uses negative punishment by taking away something the animal wants—the food. The animal associates escaping with removal of the food and will therefore decrease this behaviour. However, Watson does not describe a command system for issuing a command to the animal to encourage the animal to return to the containment zone to receive a reinforcer. Watson also does not teach feeding the animal only in response to a command. Watson feeds the animal periodically while the animal remains on the mat or chews the toy. Such a system could encourage undesired behaviour such as barking or digging if the animal associates the undesired behaviour with the food reinforcer while it remains on the mat or chews the toy.

It would therefore be advantageous to have a system that automatically locates the position of the animal relative to a containment/reinforcement zone, issues a command to the animal when it is located outside this zone, wherein the command is designed to encourage the animal to return to the containment/reinforcement zone to obtain a reinforcer, and to automatically provide the reinforcer to the animal when it returns to the reinforcement zone. It would also be advantageous if such a system was capable of permitting a trainer to effectively shape the desired returning behaviour by reinforcing successive approximations of the desired behaviour.

### SUMMARY

There is a need for an automated animal return system that overcomes the disadvantages of the prior art.

There is an other need for an automated animal return system that uses positive reinforcement training so as to avoid the development of animal confusion and nervousness.

There is a further need for an automated animal return system that can be moved to a new location and where the containment area can be changed in size without the need for the animal to relearn the boundary.

There is also a need for an automated animal return system that can be used intermittently and that does not result in creating confusion or nervousness in the animal.

According to one aspect, there is provided an automated animal return system for an animal comprising: a locator system for detecting a position of the animal relative to a reward zone; a command system for issuing a command to the animal when the locator system detects that the position of the animal is within a first boundary zone located beyond the reward zone, the command designed to encourage the animal to go to the reward zone to receive an edible reinforcer; and a positive reinforcement system for providing the reinforcer to the animal only when the locator system detects that the animal has returned to the reward zone from the first boundary zone in response to the command.

According to another aspect, there is provided a method of causing an animal to return to a predetermined reward zone comprising the steps of: automatically locating the position of the animal relative to the reward zone using a locating system; issuing a command to the animal when the locating system detects that the animal is within a first boundary zone located beyond the reward zone, the command designed to encourage the animal to return to the reward zone to receive an edible reinforcer; providing the reinforcer to the animal only when the locating system determines that the animal has returned to the reward zone in response to the command.

One advantage of the present automated animal return system is that it uses positive reinforcement training so as to avoid the development of animal confusion and nervousness. A further advantage is that it can be moved to a new location or the containment area changed in size without the need for the animal to relearn the boundary. Another advantage is that it can be used intermittently and does not result in creating confusion or nervousness in the animal if it is switched off for a period of time to engage the animal in other activities. In addition to use as a containment system, the present automated animal return system can also be used as an animal feeding system, or a herding system to move animals to a predetermined location.

Further objects and advantages of the present automated animal return system will be apparent from the following description, wherein various embodiments are clearly described and shown.

### BRIEF DESCRIPTION OF THE DRAWINGS

In drawings that illustrate the automated animal return system by way of example:

FIG. 1 is a schematic diagram of one embodiment of the present automated animal return system.

FIGS. 2, 3 and 4 are top views illustrating the various zones associated with the present automated animal return system.

Corresponding reference numerals indicate corresponding parts throughout the various figures.

### DETAILED DESCRIPTION

Studies have shown that positive reinforcement or stimulation, such as food (referred to as primary reward reinforcement) is the most effective training method for animals including dogs and other pets. However, there may be times when other conditioning methods, using aversives, such as an electric shock or discomforting noise or odor, can be effective, but most frequently only if used in conjunction with positive reinforcement.

The most effective way to teach an animal to obey a command is to associate the command with an unlearned innate reinforcer or reward, such as food. To train an animal to return or move to a desired location, a command such as “come” is issued and a food reward presented when obeyed, so that the animal associates the reward with its response to the command. Aversives, in the form of positive punishment or negative reinforcement, should only be used in conjunction with positive reinforcement.

It is therefore important to understand the difference between a reinforcer and an aversive. Reinforcers can be learned or unlearned (innate). Unlearned reinforcers include food treats or a hand touch such as patting. Learned reinforcers include audible sounds such as a tone, or a “click” or verbal phrases such as “good”, “good dog”, “good boy” and “good girl” or the like. Aversives include learned verbal phrases such as “bad dog”, or unlearned (innate) discomforts such as electric shock, painful sounds, discomforting sprays, or the like. Verbal phrases such as “come”, “here”, “home”, “get back”, “withdraw”, or “sit” are commands and are therefore considered neither a reinforcer nor an aversive.

The general concept of the present automated animal return system is to provide a system that primarily uses positive reinforcement (reinforcers) rather than positive punishment or negative reinforcement (aversives). The goal is to have the animal return or move automatically to a predetermined reinforcement or reward area by teaching the animal to obey a command such as “come” or “home” in order to obtain a reinforcer.

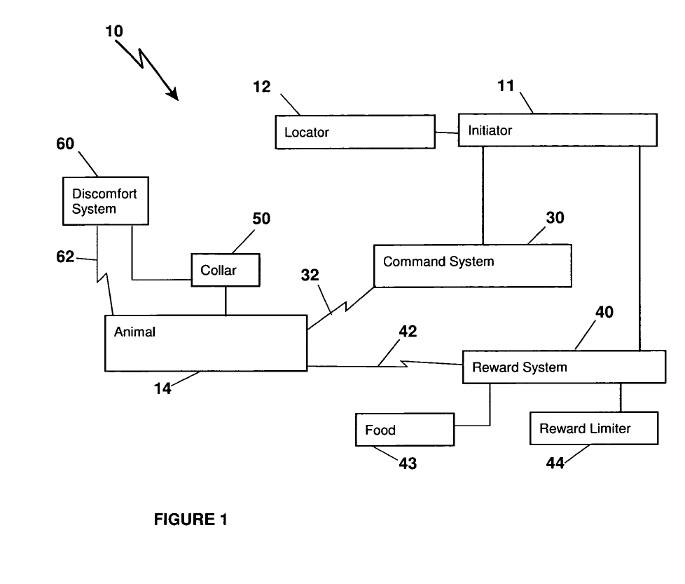

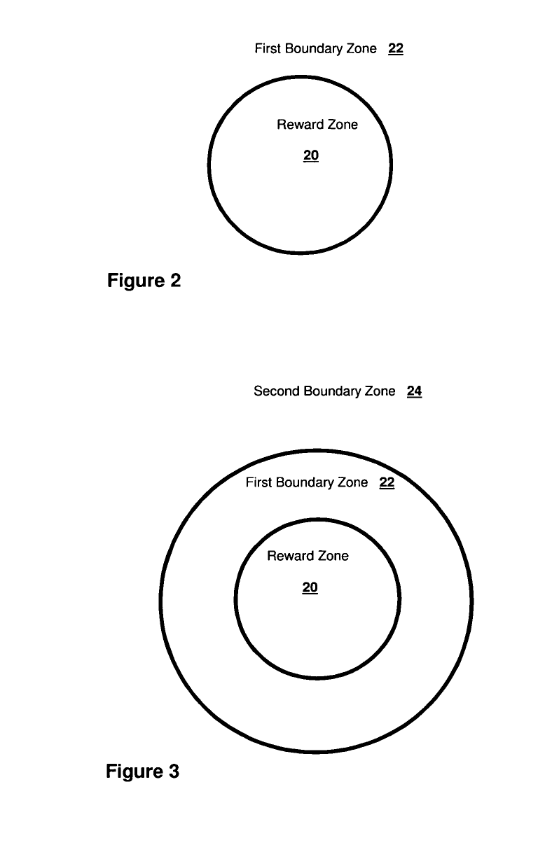

Referring to FIGS. 1 to 4, an automated animal return or containment system 10 includes an initiator 11 for generating an initiating signal that is received by a command system 30, which causes a command 32 to be issued to an animal 14. Command 32 can be any suitable command, such as a verbal command such as “come”, “home” or “here”, or a whistle that is audible to the animal, but may or may not be audible to humans. Command 32 may be a combination of a verbal command and a whistle, or may include other animal audible commands such as clicks or tones that the animal has been trained to associate with returning to a reinforcement/reward zone 20 (see FIGS. 2 to 4) to receive a reinforcer, which may be an audible reinforcer 42 or edible reinforcer 43.

Command system 30 may be any suitable command system capable of issuing command 32 to animal 14. For example, command system 30 may be a central sound generating system, including a speaker, a sound storage system and a sound amplifier, located within or near reward zone 20, that is designed to broadcast a prerecorded command 32 in a manner that is audible to animal 14. In the alternative, command system 30 may include a central radio frequency transmitter located at or near reward zone 20, combined with a radio receiver and a speaker attached to a collar 50 of animal 14. A radio frequency signal encoded with command 32 is broadcast by the central transmitter, received by the receiver on collar 50, and played to the animal over the speaker on collar 50. In a further alternative, command system 30 may include a central radio frequency transmitter located at or near reward zone 20, combined with a speaker, a sound storage and playback device, and a radio receiver attached to collar 50. The central radio transmitter of command system 30 sends a coded signal to the radio receiver on collar 50 that determines which of several stored commands 32 is to be played by the sound playback device on collar 50. In another similar alternative, discussed in further detail below, playback of command 32 is initiated from a sound generation chip and speaker attached to collar 50 in response to signals received from initiator 11.

In a first basic embodiment, initiator 11 is a timer that is set to provide the initiating signal at a predetermined time. For example, if return system 10 is being used to herd animals 14, such as cattle, back to a feeding station located within reward zone 20, initiator 11 may be set to activate the initiating signal at a predetermined feeding time. Upon receipt of the initiating signal, command system 30 issues command 32. At the same time, initiator 11 instructs a positive reinforcement/reward system 40, located within reinforcement/reward zone 20 to automatically dispense food reward or treat 43. When the cattle return to reward zone 20 they are able to eat their primary food reward 43. In a variation of this embodiment, initiator 11 may be designed to provide the initiating signal once the temperature reaches a certain point, or when the weather changes and it begins to rain, for example.

In another embodiment, automated animal return or containment system 10 includes an animal locator system 12 to determine when to activate command system 30 and to ensure that animal 14 returns toward reinforcement/reward zone 20 upon issuance of command 32. Locator system 12 must be suitable for determining the location of animal 14 relative to reward zone 20, a neutral zone 21, a first boundary zone 22, and a second boundary zone 24 (see FIGS. 2, 3 and 4). The size and configuration of these zones 20, 21, 22, and 24 are adjustable in accordance with the operator's needs. Locator system 12 can be any of several known systems that are currently used to locate the relative position of animals, such as dogs and other pets, including systems that use global position systems (GPS), systems based on radio frequency (RF) technologies including field strengths and RF encoded signals, ultrasonic based locator systems, magnetic direction sensor based systems, or accelerometer based systems, or combinations of one or more of these locator systems. Alternatively, locator system 12 may be comprised of a gate or series of gates, which may be electronic or mechanical in design, and which are capable of determining when animal 14 passes through the gate in either direction.

In one version of this embodiment, as shown in FIG. 2, reward zone 20 represents the area within which animal 14 is to be contained and can be set as desired by the operator. When animal 14 moves from reward zone 20 into first boundary zone 22, and is detected by locator system 12, initiator 11 is activated to provide an initiation signal to command system 30, which issues command 32 to encourage the animal 14 to return to reward zone 20.

Once locator system 12 detects that animal 14 has returned to, or is moving toward, reward zone 20 within a predetermined amount of time, initiator 11 instructs reward system 40 to automatically give animal 14 a reinforcer/reward. The signal by initiator 11 to reward system 40 can be RF, ultrasonic or infrared, or any other known method of transmitting such command signals.

The reinforcer/reward can be learned audible reward 42, such as a click, a tone, a whistle or a verbal phrase, such as “good” or “good boy”, or the like. Audible reward 42 can be issued from a speaker located in a central broadcast location or from a receiver/speaker unit or sound generation chip and speaker attached to collar 50, in a manner similar to that described above in association with command system 30. Such audible rewards 42 are learned responses and therefore some animals may have to be trained to respond to such rewards before they can be effectively used.

In many instances, animal 14 will require a stronger reward, often referred to as a primary reinforcer, such as food reward 43. In this embodiment, once locator system 12 detects that animal 14 has returned to reward zone 20 within a predetermined amount of time following the issuance of command 32, initiator 11, instructs reward system 40 to automatically provide animal 14 with food reward 43 in the form of an edible “treat”. Automatic food dispensing systems suitable for use in the applicant's automated animal return system are known to those skilled in the art and can easily be modified and combined with reward system 40 to dispense food reward 43 at the appropriate time when instructed by initiator 11. Reward system 40 can be designed to give either the audible reward 42 or the edible treat 43, or both.

In some cases, smart animals may intentionally go outside reward zone 20, obey command 32 and repeatedly received the food 43. Therefore, reward system 40 may include a reward limiter 44 that can be set by the operator to dispense the food reward 43 only at selected times when animal 14 returns to reward zone 20. For example, reward limiter 44 can be set to permit reward system 40 to dispense food treat 43 only after each tenth time animal 14 responds to command 32 by returning to reward zone 20. However, animal 14 will always receive audible reward 42 upon return to reward zone 20. Since the animal has been conditioned to understand that the audible reward 42, “good dog” or “click”, equals the unlearned primary reward, food treat 43, the animal views the audible reward 42 as equivalent to food 43. This association is sometimes referred to as a “bridge”, since the animal links audible reward 42 to the primary motivator, food 43.

Another method of stopping an animal from repeatedly, intentionally going outside reward zone 20 so as to receive food 43, is to have reward system 40 repeatedly feed the animal within short intervals of 10 to 30 seconds for a short period when such behaviour is detected. The animal then no longer finds it necessary to leave the reward zone 20 to receive food 43 and the escaping pattern is broken.

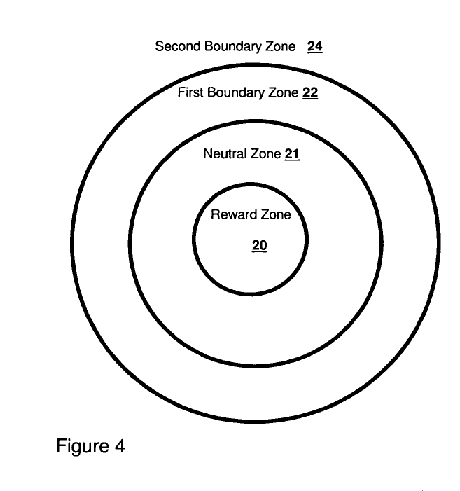

In another embodiment, as shown in FIG. 4, reinforcement/reward zone 20 is smaller than the desired containment area, perhaps having a radius of ten feet (approximately three metres) or less. A neutral containment zone 21 is located beyond reward zone 20 but within first boundary area 22. Animal 14 is permitted to remain within neutral zone 21 indefinitely without receiving command 32. As before, command 32 is issued only once animal 14 ventures into first boundary area 22, and rewards 42, 43 are not given until animal 14 returns to within the ten foot reward zone 20. Alternatively, audible reward 42 can be issued once the animal responds to command 32 and begins to return to neutral zone 21 and food reward 43 is dispensed automatically only when the animal returns to within the ten foot reward zone 20.

In the event that animal 14 does not return to neutral zone 21 or reward zone 20, as the case may be, within a predetermined amount of time, or ventures beyond first boundary zone 22 into second boundary zone 24 (see FIGS. 3 and 4), a positive punishment/discomfort system 60 (see FIG. 1) provides an aversive in the form of a discomforting stimulus 62 to animal 14, to decrease the likelihood that the escaping behaviour will occur again. The discomforting stimulus 62 may be in the form of an electric shock, delivered to the animal via small electrodes on collar 50, or some other discomfort, such as a discomforting tone broadcast from a speaker attached to collar 50 or from a central location, or an offensive spray issued from a sprayer attached to collar 50. If animal 14 obeys command 32 and returns to reward zone 20 or neutral zone 21 after receiving the discomforting stimulus 62 it will be rewarded as before. If animal 14 does not obey command 32, another command 32 is issued and the location of animal 14 is monitored to determine whether a further discomforting stimulus 62 is required or if rewards 42, 43 can be issued. If necessary, the intensity of discomforting stimulus 62 can be increased. If after a preselected number of attempts or a predetermined amount of time, the animal fails to respond to command 32 or discomforting stimulus 62, discomfort system 60 shuts down to prevent further discomfort or possible injury to the animal.

Some animals, like a puppy for example, may require dedicated training to shape the desired behaviour and ensure the effective functioning of the return system. Accordingly, the present return system 10 can be set to an optional manual training mode. In the manual training mode, animal 14 is positioned approximately 12 feet (four metres) from the center of reward zone 20 and command system 30 is manually activated by the operator to issue command 32. Once animal 14 moves into reward zone 20 reward system 40 is manually activated by the trainer to provide audible reward 42. At the same time, the primary food reward 43 is provided. Gradually, the animal can be placed at farther distances from the center of reward zone 20. Alternatively, locator system 12 can be used to determine that animal 14 has moved into reward zone 20 in response to command 32, at which point initiator 11 sends a command to reward system 40 to instruct it to automatically dispense rewards 42 and 43.

One significant advantage of the applicant's automated animal return system over existing systems is that the present return system 10 can be made portable and easily transported and installed at any location. First, all of the operable systems of the present return system 10, including initiator 11, locator system 12, command system 30, reward system 40 and discomfort system 60 can be based on technologies that are battery or solar powered and thus transportable to virtually any location. Second, and most importantly, the animal does not have to be trained to understand the location of rigid boundary lines. Animal 14 merely needs to be trained to respond to command 32. This can be easily accomplished using the applicant's automated animal return system in the training mode. One secondary benefit of this feature is that the size of reward zone 20, neutral zone 21, first boundary zone 22, and boundary zone 22 can all be made adjustable and varied at any time by the operator as desired.

The operation of one embodiment of the present automated animal return system will now be described in further detail with reference again to FIGS. 1 to 4. In this embodiment, locator system 12 is an RF based system comprising a central RF locator-transmitter preferably placed within reward zone 20 and a RF locator-receiver mounted on collar 50 attached to animal 14. The intensity of the RF signal detected by the collar-mounted locator-receiver is proportional to the distance of animal 14 from locator-transmitter in reward zone 20. The size of reward zone 20, neutral zone 21 and first and second boundary zones 22, 24 can be easily varied by the operator according to requirements. Once locator system 12 determines that animal 14 has ventured into first boundary zone 22, initiator 11, also located on collar 50, causes command system 30 to issue command 32 to animal 14 to encourage the animal to return to reward zone 20 to receive reinforcers 42 and/or 43. Command 32 may comprise the word “come” or “here” or “home”. Command 32 is a pre-recorded command issued from a sound generation chip and speaker located on collar 50 as well. Once the collar mounted locator-receiver detects a change in the RF signal strength from the central locator-transmitter, indicating that animal 14 has started to move toward neutral zone 21, initiator 11 causes reward system 40 to issue audible reward 42, which may issue from the same collar-mounted sound generation chip and speaker used to issue command 32. At the same time, initiator 11 may cause reward system 40 to dispense food reward 43 from a food dispenser located within reward zone 20. This can be accomplished using an ultrasonic signal sent from the collar-mounted speaker, or other known methods, such as infrared or RF signals. In situations where animal 14 does not respond to command 32, and locator system 12 determines that the animal has moved into second boundary zone 24, a collar-mounted discomfort system 60 can issue discomforting stimulus 62 to animal 14 in the form of an electric shock, discomforting sound, offensive spray or the like.

Since the signal from the central RF locator-transmitter can be received simultaneously by multiple collar-mounted RF locator-receivers, the above-described automated animal return system may be used to automatically monitor and contain multiple animals within a predetermined containment area. Audio reward 42 and discomforting stimulus 62 may all be based on systems mounted on the individual animal's collar 50. To ensure that only the designated animal 14 receives food reward 43 when responding to command 32, the size of reward zone 20 can be reduced to a smaller radius of perhaps one foot. Advantageously, the applicant's automated animal return system, when used with multiple animals in a single containment area, will permit the removal of a single animal 14 from the containment area by simply deactivating that animal's locator system 12, perhaps using a remote device.

It will be appreciated by those skilled in the art that only certain configurations of the present automated animal return system have been illustrated herein by the applicant, but that other configurations and designs, that fall within the scope of the present automated animal return system, as herein described by the applicant, are possible. It is therefore likely that the applicant's automated animal return system may be embodied in other specific forms without departing from the spirit or essential characteristics of the invention. The present embodiments are to be considered as illustrative and not restrictive, the scope of the automated animal return system being indicated by the appended claims rather than by the foregoing description, and all changes that come within the meaning and range of equivalency of the claims are therefore intended to be embraced therein.

I claim:

1. An automated animal return system for an animal comprising:
a locator system for detecting a position of the animal relative to a reward zone;
a command system for issuing a command to the animal when said locator system detects that said position of the animal is within a first boundary zone located beyond said reward zone, said command designed to encourage the animal to go to said reward zone to receive an edible reinforcer; and
a positive reinforcement system for providing said reinforcer to the animal only when said locator system detects that the animal has returned to said reward zone from said first boundary zone in response to said command.

2. The animal return system of claim 1, wherein said command is selected from a group of audible commands consisting of clicks, tones, whistles and verbal commands.

3. The animal return system of claim 1, wherein said locator system is selected from a group of locator systems consisting of GPS based locators, RF based locators, ultrasonic based locators, magnetic direction sensor based locators, accelerometer based locators, manual gate systems, electronic gate systems and combinations thereof.

4. The animal return system of claim 1, wherein said positive reinforcement system is adapted to provide an audible reinforcer to the animal when said locator system detects that the animal begins to return to the reward zone, said audible reinforcer selected from the group of audible reinforcers consisting of a click, a tone, a whistle and a verbal phrase.

5. The animal return system of claim 4, wherein said audible reinforcer is broadcast from a speaker located in or near said reward zone.

6. The animal return system of claim 4, wherein said audible reinforcer is broadcast from a speaker mounted on a collar attached to the animal.

7. The animal return system of claim 4, wherein said audible reinforcer is prerecorded.

8. The animal return system of claim 1, including a reward limiter to limit the provision of said edible reinforcer to selected times when the animal returns from said first boundary zone to said reward zone in response to said command.

9. The animal return system of claim 8, wherein said selected times are determined based on a fraction of a total number of times the animal has returned from said first boundary zone to said reward zone in response to said command.

10. The animal return system of claim 1, wherein said command is broadcast from a speaker located in or near said reward zone.

11. The animal return system of claim 1, wherein said command is broadcast from a speaker mounted on a collar attached to the animal.

12. The animal return system of claim 1, wherein said command is a prerecorded command.

13. The animal return system of claim 1, including a positive punishment system for applying a discomfort to the animal when said locator system detects that the animal has moved beyond said first boundary zone into a second boundary zone, or when said locator system detects that the animal has not moved toward said reward zone after a predetermined amount of time following the issuance of said command.

14. The animal return system of claim 13, wherein said discomfort is selected from a group of discomforts consisting of an electric stimulus administered by electrodes attached to a collar secured to the animal, an audible tone broadcast from a speaker attached to said collar secured to the animal or from a central location, and an offensive spray issued from a spray system attached to said collar secured to the animal, or combinations of the above-listed discomforts.

15. The animal return system of claim 13, wherein the intensity of said discomfort is variable.

16. The animal return system of claim 13, wherein said discomfort is discontinued after a predetermined amount of time or following a predetermined number of applications.

17. The animal return system of claim 1, wherein said return system is operable in a training mode to enable a trainer to train the animal to respond to said command, said training mode including a manual command mode to enable said trainer to manually cause said command to be issued.

18. The animal return system of claim 17, wherein said training mode also includes a manual reward mode to enable said trainer to manually activate said reward system.

19. The animal return system of claim 1, wherein the sizes of said first boundary zone and said reward zone are variable.

20. The animal return system of claim 1, wherein the return system is portable for operation at a remote location.

21. The animal return system of claim 1, wherein said positive reinforcement system is further adapted to provide an audible reinforcer to the animal when said locator system detects that the animal has returned to a neutral zone located between said reward zone and said first boundary zone in response to said command.

22. A method of causing an animal to return to a predetermined reward zone comprising the steps of:
automatically locating the position of the animal relative to the reward zone using a locating system;
issuing a command to the animal when said locating system detects that the animal is within a first boundary zone located beyond said reward zone, said command designed to encourage the animal to return to the reward zone to receive an edible reinforcer; and
providing said reinforcer to the animal only when said locating system determines that the animal has returned to the reward zone in response to said command.
